(19) United States
(12) Patent Application Publication
(10) Pub. No.: US 2011/0255003 A1
(43) Pub. Date: Oct. 20, 2011

(54) METHOD AND APPARATUS FOR PRESENTING ON-SCREEN GRAPHICS IN A FRAME-COMPATIBLE 3D FORMAT

(75) Inventors: Romulo Pontual, Hermosa Beach, CA (US); Hanno Basse, Santa Monica, CA (US)

(73) Assignee: The DIRECTV Group, Inc., El Segundo, CA (US)

(21) Appl. No.: 12/762,017

(22) Filed: Apr. 16, 2010

(51) Int. Cl. H04N 5/50

(52) U.S. Cl. 348/569; 348/E05.097

(57) ABSTRACT

A method and apparatus for rendering an OSD on a background frame having a plurality of background subframes together defining a 3D image is disclosed. In one embodiment, the method comprises the steps of generating a first background subframe describing a first perspective and having an overlaid OSD, generating a second background subframe describing the first perspective and having the overlaid OSD, and providing the first background subframe describing the first perspective and having the overlaid OSD and the second background subframe having the overlaid OSD to a display.

### BACKGROUND OF THE INVENTION

1. Field of the Invention

The present invention relates to systems and methods for providing user interfaces in conjunction with the presentation of media programs.

2. Description of the Related Art

The presentation of three-dimensional (3D) pictures dates back from the 1800s. 3D moving pictures provide an illusion of depth perception by presenting images from two slightly different perspectives, with each perspective presented to one of the viewer's eyes. The two perspectives can be recorded by a stereoscopic camera as two separate images, or by computer generated imagery. Initially offered in film theatrical releases, three dimensional moving pictures (3D media programs) can now be provided in television broadcasts, DVDs, and videotapes.

One factor that has limited widespread presentation of 3D media programs is a lack of standardization regarding the creation, transmission, and reproduction of the separate images. It is advantageous if 3D media programs can be transmitted and reproduced using legacy equipment that is now used to record, transmit, and reproduce two-dimensional (2D) media programs.

3D broadcast television service will soon be available to home consumers having 3D enabled television sets. 3D media programs include video frames that have two video subframes, each subframe representing an image intended for either the right or left eye. These subframes are multiplexed in the signal. Compatible television sets receive the multiplexed signal, and reproduce one subframe after the other, and using different techniques, present only the proper frames to each eye. This may be accomplished using a wide variety of proposed techniques. One such technique is by use of shuttered glasses that are worn by the viewer. The television commands each eye portion of the glasses to become opaque when the presented subframe is not intended for that eye and to become clear when the presented subframe is intended for that eye. In this way, each eye can view only the sub frame for which it was intended.

The multiplexing of the video subframes could be accomplished in a number of ways, including the separate identification and transmission of each subframe. However, this would not be compatible with legacy transmission and reception systems. Another technique is to combine the subframes into the same frame of video. This can be accomplished by placing the images intended for each eye on different portions of the transmitted video frame. When the subframes are multiplexed in this way, legacy (2D) equipment can be used to transmit the 3D signal to remote receivers, and the remote receivers can receive and process the signal just as they would an ordinary 2D signal, and provide the signal to a 3D compatible television set. The television set recognizes that the signal comprises 3D information, and presents the information in each of the portions of the frame one at a time, to reproduce a 3D image.

One problem with such 3D systems is the presentation of on-screen displays (OSDs). OSD are typically generated in the receiver and provide information to the user (often, in response to a command issued by the user) that are used to which media program is presented and how it is presented. One example of an OSD is a program guide. Another example is information that may be presented when the user selects a channel change. Typically, OSDs are overlaid on each frame of video before it is passed to the display. This technique works well when the OSD is overlaid upon a 2D-video frame, but results in an incomprehensible image when overlaid on a 3D-video frame.

What is needed is a method and apparatus for presenting an OSD on a 3D compatible video image. The present invention satisfies that need.

### SUMMARY OF THE INVENTION

To address the requirements described above, the present invention discloses a method and apparatus for rendering an OSD on a background frame having a plurality of background subframes together defining a 3D image. In one embodiment, the method comprises the steps of generating a first background subframe describing a first perspective and having an overlaid OSD, generating a second background subframe describing the first perspective and having the overlaid OSD, and providing the first background subframe describing the first perspective and having the overlaid OSD and the second background subframe having the overlaid OSD to a display. In a further embodiment, the step of generating a first background subframe describing a first perspective and having an overlaid OSD comprises the steps of generating the OSD and overlaying the OSD on the first background subframe and the step of generating the second background subframe describing the second perspective having the overlaid OSD comprises the step of copying the first background subframe having the OSD to the second background subframe. In a second further embodiment, the step of generating the second background subframe describing the second perspective having the overlaid OSD comprises the steps of copying the first background subframe to the second background subframe, generating the OSD, and overlaying the OSD on the second background subframe and the step of generating a first background subframe describing a first perspective and having an overlaid OSD comprises the step of overlaying the OSD on the first background subframe.

The present invention can also be described as an apparatus for performing one or more of the above steps. The apparatus may include a processor having instructions for performing the steps stored in a memory communicatively coupled to the processor, or may include a special purpose hardware processor that performs the required functions using electronic circuitry by itself or in combination with a processor and memory storing such instructions.

### BRIEF DESCRIPTION OF THE DRAWINGS

Referring now to the drawings in which like reference numbers represent corresponding parts throughout:

FIG. 1 is a diagram illustrating an overview of a distribution system that can be used to provide video data, software updates, and other data to subscribers;

FIG. 2 is a block diagram showing a typical uplink configuration for a single satellite 108 transponder;

FIG. 3 is a block diagram of one embodiment of the program guide subsystem;

FIG. 4A is a diagram of a representative data stream;

FIG. 4B is a diagram of a data packet;

FIG. 4C is a diagram of an MPEG data packet;

FIG. 5 is a block diagram of an exemplary set top box;

FIGS. 6-9 are diagrams depicting frame-compatible 3D formats;

FIG. 10 is a diagram illustrating the result if an OSD were added to a background video frame using a frame compatible side-by side format;

FIG. 11 is a diagram illustrating exemplary method steps that can be used to render the OSD on one or more decoded video frames before those frames are provided to a display for presentation to the subscriber;

FIG. 12 is a diagram illustrating exemplary method steps in which the first background subframe and overlaid OSD is generated, then copied to a second background subframe;

FIGS. 13 and 14 are diagrams illustrating how the background subframe may appear after the OSD is overlaid on one subframe in the side-by-side and top/bottom frame-compatible 3D formats, respectively;

FIGS. 15 and 16 are diagrams illustrating how the background subframe may appear after the OSD is overlaid on both subframes in the side-by-side and top/bottom frame-compatible 3D formats, respectively; and

FIG. 17 is a diagram illustrating another embodiment of exemplary method steps that can be used to render the OSD on one or more decoded video frames before those frames are provided to a display for presentation to the subscriber.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Distribution System

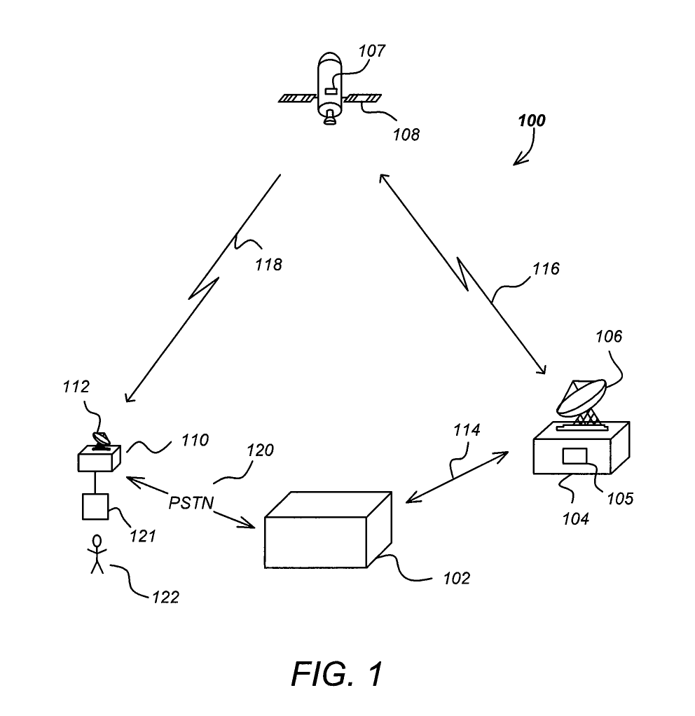

FIG. 1 is a diagram illustrating an overview of a distribution system 100 that can be used to provide video data, software updates, and other data to subscribers. The distribution system 100 comprises a control center 102 in communication with an uplink center 104 (together hereafter alternatively referred to as a headend) via a ground or other link 114 and with a subscriber receiver station 110 via a public switched telephone network (PSTN) or other link 120. The control center 102, or headend provides program material (e.g. video programs, audio programs, software updates, and other data) to the uplink center 104 and coordinates with the subscriber receiver stations 110 to offer, for example, pay-per-view (PPV) program services, including billing and associated decryption of video programs.

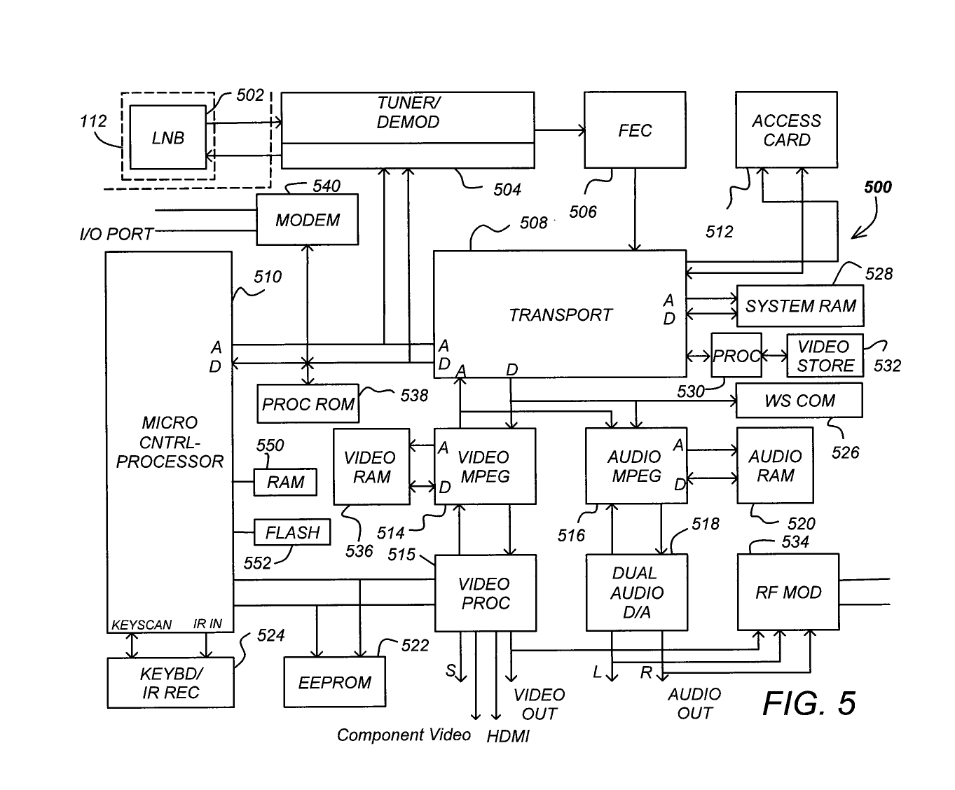

The uplink center receives program material and program control information from the control center 102, and using an uplink antenna 106 and transmitter 105, transmits the program material and program control information to the satellite 108. The satellite 108 receives and processes this information, and transmits the video programs and control information to the subscriber receiver station 110 via downlink 118 using one or transponders 107 or transmitters. The subscriber receiving station 110 comprises a receiver (described herein with respect to FIG. 5) communicatively coupled to an outdoor unit (ODU) 112 and a display 121. The receiver processes the information received from the satellite 108 and provides the processed information to the display 121 for viewing by the subscriber 122. The ODU may include a subscriber antenna and a low noise block converter (LNB).

In one embodiment, the subscriber receiving station antenna is an 18-inch slightly oval-shaped antenna. Standard definition transmissions are typically in the Ku-band, while the high definition (HD) transmissions are typically in the Ka band. The slight oval shape is due to the 22.5 degree offset feed of the LNB which is used to receive signals reflected from the subscriber antenna. The offset feed positions the LNB out of the way so it does not block any surface area of the antenna minimizing attenuation of the incoming microwave signal.

The distribution system 100 can comprise a plurality of satellites 108 in order to provide wider terrestrial coverage, to provide additional channels, or to provide additional bandwidth per channel. In one embodiment of the invention, each satellite comprises 16 transponders to receive and transmit program material and other control data from the uplink center 104 and provide it to the subscriber receiving stations 110. Using data compression and multiplexing techniques, two satellites 108 working together can receive and broadcast over 150 conventional (non-HDTV) audio and video channels via 32 transponders.

While the invention disclosed herein will be described with reference to a satellite based distribution system 100, the present invention may also be practiced with terrestrial-based transmission of program information, whether by broadcasting means, cable, or other means. Further, the different functions collectively allocated among the control center 102 and the uplink center 104 as described above can be reallocated as desired without departing from the intended scope of the present invention.

Although the foregoing has been described with respect to an embodiment in which the program material delivered to the subscriber 122 is video (and audio) program material such as a movie, the foregoing method can be used to deliver program material comprising purely audio information or other data as well. It is also used to deliver current receiver software and announcement schedules for the receiver to rendezvous to the appropriate downlink 118. Link 120 may be used to report the receiver's current software version.

### Uplink Configuration

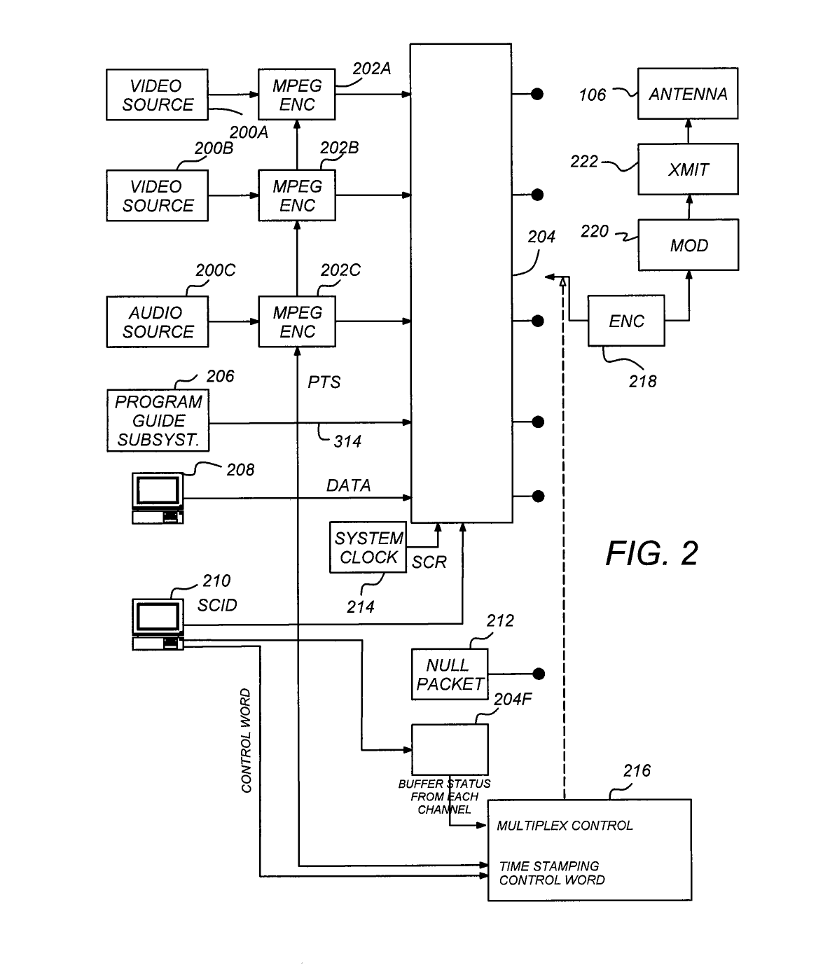

FIG. 2 is a block diagram showing a typical uplink configuration for a single satellite 108 transponder, showing how video program material is uplinked to the satellite 108 by the control center 102 and the uplink center 104. FIG. 2 shows two video channels of information from video sources 200A and 200B (which could be augmented respectively with one or more audio channels for high fidelity music, soundtrack information, or a secondary audio program for transmitting foreign languages, for example, audio source 200C), and a data channel from a program guide subsystem 206 and data such as software updates from a data source 208.

The video channels are provided by a program source of video material 200A-200B (collectively referred to hereinafter as video source(s) 200). The data from each video program source 200 is provided to an encoder 202A-202B (collectively referred to hereinafter as encoder(s) 202). The audio channel is provided by a program source of audio material 200C and provided to encoder 202C. Each of the encoders 202A-202C accepts a presentation time stamp (PTS) from the controller 216. The PTS is a wrap-around binary time stamp that is used to assure that the video information is properly synchronized with the audio information after encoding and decoding. A PTS time stamp is sent with each I-frame of the MPEG encoded data.

In one embodiment of the present invention, each encoder 202 is a Motion Picture Experts Group (MPEG) encoder, but other decoders implementing other coding techniques can be used as well. The data channel can be subjected to a similar compression scheme by an encoder (not shown), but such compression is usually either unnecessary, or performed by computer programs in the computer data source (for example, photographic data is typically compressed into *.TIF files or *JPG files before transmission). After encoding by the encoders 202, the signals are converted into data packets by a packetizer 204.

The data packets are assembled using a reference from the system clock 214 (SCR), and from the conditional access manager 210, which provides the SCID to the packetizers 204 for use in generating the data packets. These data packets are then multiplexed into serial data and transmitted. As described below, alternate versions of the media programs are generated and used for watermarking purposes. These alternate versions can be generated in the MPEG encoder used to encode the media program (e.g. MPEG encoder 202A for video source 200A) or by a separate MPEG encoder similar to MPEG encoders 202A-202C.

### Program Guide Subsystem

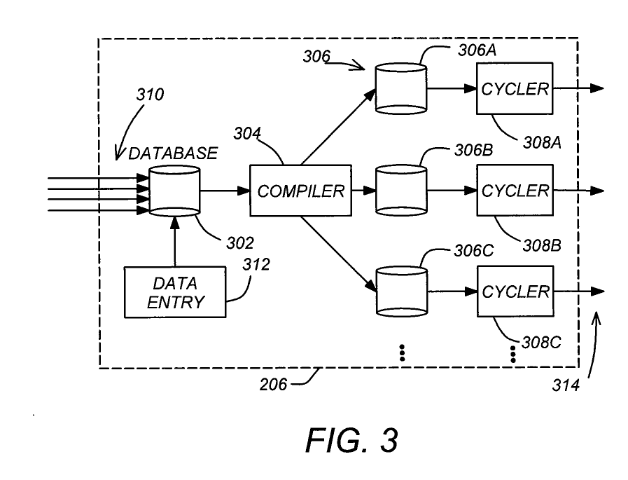

FIG. 3 is a block diagram of one embodiment of the program guide subsystem 206. The program guide data transmitting system 206 includes program guide database 302, compiler 304, sub-databases 306A-306C (collectively referred to as sub-databases 306) and cyclers 308A-308C (collectively referred to as cyclers 308).

Schedule feeds 310 provide electronic schedule information about the timing and content of various television channels, such as that found in television schedules contained in newspapers and television guides. Schedule feeds 310 preferably include information from one or more companies that specialize in providing schedule information, such as GNS, TRIBUNE MEDIA SERVICES, and T.V. DATA. The data provided by companies such as GNS, TRIBUNE MEDIA SERVICES and T.V. DATA are typically transmitted over telephone lines or the Internet to program guide database 302. These companies provide television schedule data for all of the television stations across the nation plus the nationwide channels, such as SHOWTIME, HBO, and the DISNEY CHANNEL. The specific format of the data that are provided by these companies varies from company to company. Program guide database 302 preferably includes schedule data for television channels across the entire nation including all nationwide channels and local channels, regardless of whether the channels are transmitted by the transmission station.

Program guide database 302 is a computer-based system that receives data from schedule feeds 310 and organizes the data into a standard format. Compiler 304 reads the standard form data out of program guide database 302, identifies common schedule portions, converts the program guide data into the proper format for transmission to users (specifically, the program guide data are converted into objects as discussed below) and outputs the program guide data to one or more of sub-databases 308.

Program guide data are also manually entered into program guide database 302 through data entry station 312. Data entry station 312 allows an operator to enter additional scheduling information, as well as combining and organizing data supplied by the scheduling companies. As with the computer organized data, the manually entered data are converted by the compiler into separate objects and sent to one or more of sub-databases 306.

The program guide objects are temporarily stored in sub-databases 306 until cyclers 308 request the information. Each of cyclers 308 preferably transmits objects at a different rate than the other cyclers 308. For example, cycler 308A may transmit objects every second, while cyclers 308B and 308C may transmit objects every 5 seconds and every 10 seconds, respectively.

Since the subscriber's receivers may not always be on and receiving and saving objects, the program guide information is continuously re-transmitted. Program guide objects for programs that will be shown in the next couple of hours are sent more frequently than program guide objects for programs that will be shown later. Thus, the program guide objects for the most current programs are sent to a cycler 308 with a high rate of transmission, while program guide objects for later programs are sent to cyclers 308 with a lower rate of transmission. One or more of the data outputs 314 of cyclers 308 are forwarded to the packetizer of a particular transponder, as depicted in FIG. 2.

It is noted that the uplink configuration depicted in FIG. 2 and the program guide subsystem depicted in FIG. 3 can be implemented by one or more hardware modules, one or more software modules defining instructions performed by a processor, or a combination of both.

### Format of Transmitted Program Guide Data

Prior to transmitting program guide data to sub-databases 306, compiler 304 organizes the program guide data from program guide database 302 into objects. Each object preferably includes an object header and an object body. The object header identifies the object type, object ID and version number of the object. The object type identifies the type of the object. The various types of objects are discussed below. The object ID uniquely identifies the particular object from other objects of the same type. The version number of an object uniquely identifies the object from other objects of the same type and object ID. The object body includes data for constructing a portion of a program guide that is ultimately displayed on a user's television.

Prior to transmission, each object is preferably broken down by compiler 304 into multiple frames. Each frame is made up of a plurality of 126 byte packets with each such packet marked with a service channel identification (SCID) number. The SCIDs are later used by receiver or set top box to identify the packets that correspond to each television channel. Each frame includes a frame header, program guide data and a checksum. Each frame header includes the same information as the object header described above—object type, object ID and version number. The frame header uniquely identifies the frame, and its position within a group of frames that make up an object. The program guide data within frames are used by set top box (shown in FIG. 5) to construct and display a program guide and other information on a user's television. The checksum is examined by set top box 500 to verify the accuracy of the data within received frames.

The following is a list of preferred object types, although many additional or different object types may be used: boot object, data announcement object, update list object, channel object, schedule object, program object, time object, deletion object, and a reserved object.

A boot object (BO) identifies the SCIDs where all other objects can be found. A BO is always transmitted on the same channel, which means that each packet of data that makes up a BO is marked with the same SCID number. BOs are transmitted frequently to ensure that set top boxes 500 which have been shut off, and are then turned back on, immediately receive information indicating the location of the various program guide objects. Thus, BOs are sent from compiler 304 to a cycler 308 with a high rate of transmission.

A data announcement object (DAO) is an object that includes data that is to be announced to some or all of the set top boxes. The DAO can be used in the system described below to indicate that there is updated software to be installed in the set top box.

An update list object (ULO) contains a list of all the channel objects (COs), which are discussed below) in a network. A network is a grouping of all channels from a common source, such as all Digital Satellite System (DSAT) channels. For each channel object in the list of channel objects, the channel list object includes a channel object ID for that channel object. Each channel object is uniquely identified by its channel object ID.

Each channel object provides information about a particular channel. Each channel object points to a schedule object (discussed further below). Each channel object includes multiple fields or descriptors that provide information about that channel. Each descriptor includes a descriptor type ID that indicates the type of the descriptor. Descriptor types include “about” descriptors, “category” descriptors, and “reserved” descriptors. The “about” descriptor provides a description of the channel. When there is no “about” descriptor, the description defaults to a message such as “No Information Available”. The “category” descriptor provides a category classification for the channel. More than one “category” descriptor can appear in the channel object if the channel falls into more than one category. “Category” descriptors preferably provide a two-tiered category classification, such as “sports/baseball” or “movie/drama”, although any number of tiers may be used including single tiers. “Reserved” descriptors are saved for future improvements to the system.

A program object (PO) provides a complete description of a program. The program object is pointed to by other objects (namely, schedule objects, and HTML objects) that contain the starting time and duration of the program. Like channel objects, descriptors are used within program objects. Program objects use the same types of descriptors as channel objects. Category descriptors provide a category classification for a program and “about” descriptors provide a description of the program. If compiler 52 determines that a particular program is scheduled to appear on multiple channels, the program object for that program is transmitted a single time for the multiple channels, although, as discussed above, it may be retransmitted multiple times.

A schedule object (SO) points to a group of program objects. A schedule object is assigned a time duration by a schedule object (discussed below). Each schedule object identifies all of the program objects that must be acquired for the assigned time duration. Each schedule object is uniquely identified by a schedule object ID. A unique schedule object may be pointed to by more than one schedule object. As time progresses and the scheduling information becomes stale, the schedule object is no longer needed. Schedule objects that are not referenced by any schedule object are discarded by set top box 500.

A schedule object (SO) contains the start time of the entire schedule, as well as the start time and duration of the general program objects. A schedule object points to program objects. The start time of each schedule object is given by its start time. As time progresses and the scheduling information becomes stale, a new schedule object replaces the previous version, and updates the scheduling information. Thus, the channel object of the schedule object need not be updated. Only the schedule object is updated.

A time object (TO) provides the current time of day and date at transmission station 26. Time objects include format codes that indicate which part of the date and time is to be displayed. For example, the only part of the date of interest might be the year. Similarly, whenever dates and times are transmitted within an object, the dates and times are accompanied by format codes. The format codes instruct set top box 500 which portion of the transmitted date and time to display.

A deletion object (DO) provides a list of object IDs that set top box 500 must discard.

Reserved objects are saved for future improvements to the program guide system. When a new type of object is defined, all objects of that new type will include an object header with a reserved object type.

### Broadcast Data Stream Format and Protocol

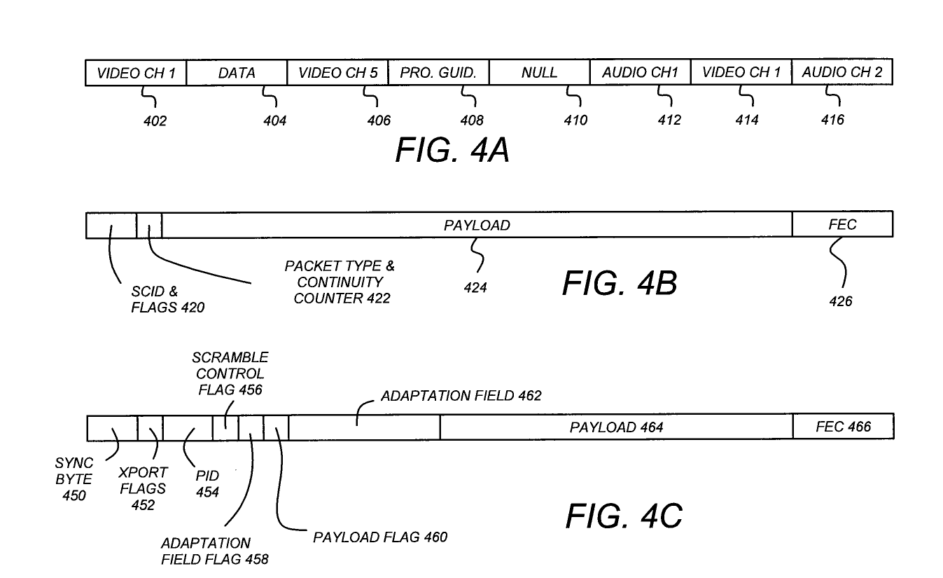

FIG. 4A is a diagram of a representative data stream. The first packet segment 402 comprises information from video channel 1 (data coming from, for example, the first video program source 200A). The next packet segment 404 comprises computer data information that was obtained, for example from the computer data source 208. The next packet segment 406 comprises information from video channel 5 (from one of the video program sources 200). The next packet segment 408 comprises program guide information such as the information provided by the program guide subsystem 206. As shown in FIG. 4A, null packets 410 created by the null packet module 212 may be inserted into the data stream as desired.

The data stream therefore comprises a series of packets from any one of the data sources in an order determined by the controller 216. The data stream is encrypted by the encryption module 218, modulated by the modulator 220 (typically using a QPSK modulation scheme), and provided to the transmitter 222, which broadcasts the modulated data stream on a frequency bandwidth to the satellite via the antenna 106. The receiver 200 receives these signals, and using the SCID, reassembles the packets to regenerate the program material for each of the channels.

FIG. 4B is a diagram showing one embodiment of a data packet for one transport protocol that can be used with the present invention. Each data packet (e.g. 402-416) is 147 bytes long, and comprises a number of packet segments. The first packet segment 420 comprises two bytes of information containing the SCID and flags. The SCID is a unique 12-bit number that uniquely identifies the data packet's data channel. The flags include 4 bits that are used to control whether the packet is encrypted, and what key must be used to decrypt the packet. The second packet segment 422 is made up of a 4-bit packet type indicator and a 4-bit continuity counter. The packet type identifies the packet as one of the four data types (video, audio, data, or null). When combined with the SCID, the packet type determines how the data packet will be used. The continuity counter increments once for each packet type and SCID. The next packet segment 424 comprises 127 bytes of payload data, which is a portion of the video program provided by the video program source 300 or other audio or data sources. The final packet segment 426 is data required to perform forward error correction.

The present invention may also be implemented using MPEG transport protocols. FIG. 4C is a diagram showing another embodiment of a data packet for the MPEG-2 protocol. Each data packet comprises a sync byte 450, three transport flags 453, and a packet identifier (PID) 454. The sync byte 450 is used for packet synchronization. The transport flags include a transport error indicator flat (set if errors cannot be corrected in the data stream), a payload unit start indicator (indicting the start of PES data or PSI data, and a transport priority flag). The PID 454 is analogous to the SCID discussed above in that it identifies a data channel. A demultiplexer in the transport chip discussed below extracts elementary streams from the transport stream in part by looking for packets identified by the same PID. As discussed below, time-division multiplexing can be used to decide how often a particular PID appears in the transport stream. The scramble control flag 456 indicates how the payload is scrambled, the adaptation field flag 458 indicates the presence of an adaptation field, and the payload flag 460 indicates that the packet includes payload.

### Set Top Box

FIG. 5 is a block diagram of a set top box (STB) 500 (also hereinafter alternatively referred to as receiver or integrated receiver/decoder, or IRD). The set top box 500 is part of the receiver station and may comprise a tuner/demodulator 504 communicatively coupled to an ODU 112 having one or more LNBs 502. The LNB 502 converts the 12.2 to 12.7 GHz downlink 118 signal from the satellites 108 to, e.g., a 950-1450 MHz signal required by the set top box's 500 tuner/demodulator 504. The LNB 502 may provide either a dual or a single output. The single-output LNB 502 has only one RF connector, while the dual output LNB 502 has two RF output connectors and can be used to feed a second tuner 504, a second set top box 500 or some other form of distribution system.

The tuner/demodulator 504 isolates a single, digitally modulated transponder, and converts the modulated data to a digital data stream. As packets are received, the tuner/demodulator 504 identifies the type of each packet. If tuner/demodulator 504 identifies a packet as program guide data, tuner/demodulator 504 outputs the packet to memory 78. The digital data stream is then supplied to a forward error correction (FEC) decoder 506. This allows the set top box 500 to reassemble the data transmitted by the uplink center 104 (which applied the forward error correction to the desired signal before transmission to the subscriber receiving station 110) verifying that the correct data signal was received and correcting errors, if any. The error-corrected data may be fed from the FEC decoder module 506 to the transport module 508 via an 8-bit parallel interface.

The transport module 508 performs many of the data processing functions performed by the set top box 500. The transport module 508 processes data received from the FEC decoder module 506 and provides the processed data to the video MPEG decoder 514, the audio MPEG decoder 516, and the microcontroller 150 and/or data storage processor 530 for further data manipulation. In one embodiment of the present invention, the transport module, video MPEG decoder and audio MPEG decoder are all implemented on integrated circuits. This design promotes both space and power efficiency, and increases the security of the functions performed within the transport module 508. The transport module 508 also provides a passage for communications between the microprocessor 510 and the video and audio MPEG decoders 514, 516. As set forth more fully hereinafter, the transport module also works with the conditional access module (CAM) 512 to determine whether the subscriber receiving station 110 is permitted to access certain program material. Data from the transport module can also be supplied to external communication module 526.

The CAM 512 functions in association with other elements to decode an encrypted signal from the transport module 508. The CAM 512 may also be used for tracking and billing these services. In one embodiment of the present invention, the CAM 512 is a smart card, having contacts cooperatively interacting with contacts in the set top box 500 to pass information. In order to implement the processing performed in the CAM 512, the set top box 500, and specifically the transport module 508 provides a clock signal to the CAM 512.

Video data is processed by the MPEG video decoder 514. Using the video random access memory (RAM) 536, the MPEG video decoder 514 decodes the compressed video data and sends it to an encoder or video processor 515, which converts the digital video information received from the video MPEG module 514 into an output signal usable by a display or other output device. By way of example, processor 515 may comprise a National TV Standards Committee (NTSC) or Advanced Television Systems Committee (ATSC) encoder. In one embodiment of the invention both S-Video, baseband video and RF modulated video (NTSC or ATSC) signals are provided. Other outputs may also be utilized, and are advantageous if high definition programming is processed. Such outputs may include, for example, component video and the high definition multimedia interface (HDMI).

Audio data is likewise decoded by the MPEG audio decoder 516. The decoded audio data may then be sent to a digital to analog (D/A) converter 518. In one embodiment of the present invention, the D/A converter 518 is a dual D/A converter, one for the right and left channels. If desired, additional channels can be added for use in surround sound processing or secondary audio programs (SAPs). In one embodiment of the invention, the dual D/A converter 518 itself separates the left and right channel information, as well as any additional channel information. Other audio formats such as DOLBY DIGITAL AC-3 may similarly be supported.

A description of the processes performed in the encoding and decoding of video streams, particularly with respect to MPEG and JPEG encoding/decoding, can be found in Chapter 8 of “Digital Television Fundamentals,” by Michael Robin and Michel Poulin, McGraw-Hill, 1998, which is hereby incorporated by reference herein.

The microprocessor 510 receives and processes command signals from the remote control 524, an set top box 500 keyboard interface, modem 540, and transport 508. The microcontroller receives commands for performing its operations from a processor programming memory, which permanently stores such instructions for performing such commands. The memory used to store data for microprocessor 510 and/or transport 508 operations may comprise a read only memory (ROM) 538, an electrically erasable programmable read only memory (EEPROM) 522, a flash memory 552 and/or a random access memory 550, and/or similar memory devices. The microprocessor 510 also controls the other digital devices of the set top box 500 via address and data lines (denoted “A” and “D” respectively, in FIG. 5).

The modem 540 connects to the customer's phone line via the PSTN port 120. It calls, e.g.

the program provider, and transmits the customer's purchase information for billing purposes, and/or other information. The modem 540 is controlled by the microprocessor 510. The modem 540 can output data to other I/O port types including standard parallel and serial computer I/O ports. Data can also be obtained from a cable or digital subscriber line (DSL) modem, or any other suitable source.

The set top box 500 may also comprise a local storage unit such as the storage device 532 for storing video and/or audio and/or other data obtained from the transport module 508. Video storage device 532 can be a hard disk drive, a read/writeable compact disc of DVD, a solid state RAM, or any other storage medium. In one embodiment of the present invention, the video storage device 532 is a hard disk drive with specialized parallel read/write capability so that data may be read from the video storage device 532 and written to the device 532 at the same time. To accomplish this feat, additional buffer memory accessible by the video storage 532 or its controller may be used. Optionally, a video storage processor 530 can be used to manage the storage and retrieval of the video, audio, and/or other data from the storage device 532. The video storage processor 530 may also comprise memory for buffering data passing into and out of the video storage device 532. Alternatively or in combination with the foregoing, a plurality of video storage devices 532 can be used. Also alternatively or in combination with the foregoing, the microprocessor 510 can also perform the operations required to store and or retrieve video and other data in the video storage device 532.

The video processing module 515 output can be directly supplied as a video output to a viewing device such as a video or computer monitor. In addition the video and/or audio outputs can be supplied to an RF modulator 534 to produce an RF output and/or 8 vestigal side band (VSB) suitable as an input signal to a conventional television tuner. This allows the set top box 500 to operate with televisions without a video input.

Each of the satellites 108 comprises one or more transponders, each of which accepts program information from the uplink center 104, and relays this information to the subscriber receiving station 110. Known multiplexing techniques are used so that multiple channels can be provided to the user. These multiplexing techniques include, by way of example, various statistical or other time domain multiplexing techniques and polarization multiplexing. In one embodiment of the invention, a single transponder operating at a single frequency band carries a plurality of channels identified by respective SCIDs.

Preferably, the set top box 500 also receives and stores a program guide in a memory available to the microprocessor 510. Typically, the program guide is received in one or more data packets in the data stream from the satellite 108. The program guide can be accessed and searched by the execution of suitable operation steps implemented by the microcontroller 510 and stored in the processor ROM 538. The program guide may include data to map viewer channel numbers to satellite networks, satellite transponders and SCIDs, and also provide TV program listing information to the subscriber 122 identifying program events.

Initially, as data enters the set top box 500, the tuner/demodulator 504 looks for a boot object. Boot objects are always transmitted with the same SCID number, so tuner 504 knows that it must look for packets marked with that identification number. A boot object identifies the identification numbers where all other objects can be found.

As data is received and stored in the memory, the microprocessor 510 acts as a control device and performs various operations on the data in preparation for processing the received data. These operations include packet assembly, object assembly and object processing.

The first operation performed on data objects stored in the memory 550 is packet assembly. During the packet assembly operation, microprocessor 510 examines the stored data and determines the locations of the packet boundaries.

The next step performed by microprocessor 510 is object assembly. During the object assembly step, microprocessor 510 combines packets to create object frames, and then combines the object frames to create objects. Microprocessor 510 examines the checksum transmitted within each object frame, and verifies whether the frame data was accurately received. If the object frame was not accurately received, it is discarded from memory 550. Also during the object assembly step, the microprocessor 510 discards assembled objects that are of an object type that the microprocessor 510 does not recognize. The set top box 500 maintains a list of known object types in memory 550. The microprocessor 510 examines the object header of each received object to determine the object type, and the microprocessor 510 compares the object type of each received object to the list of known object types stored in memory 550. If the object type of an object is not found in the list of known object types, the object is discarded from memory 550. Similarly, the set top box 500 maintains a list of known descriptor types in memory 550, and discards any received descriptors that are of a type not in the list of known descriptor types.

The last step performed by microprocessor 510 on received object data is object processing. During object processing, the objects stored in the memory 550 are combined to create a digital image. Instructions within the objects direct microprocessor 510 to incorporate other objects or create accessible user-links. Some or all of the digital images can be later converted to an analog signal that is sent by the set top box 500 to a television or other display device for display to a user.

The functionality implemented in the set top box 500 depicted in FIG. 5 can be implemented by one or more hardware modules, one or more software modules defining instructions performed by a processor, or a combination of both.

### 3D Media Program Protocols

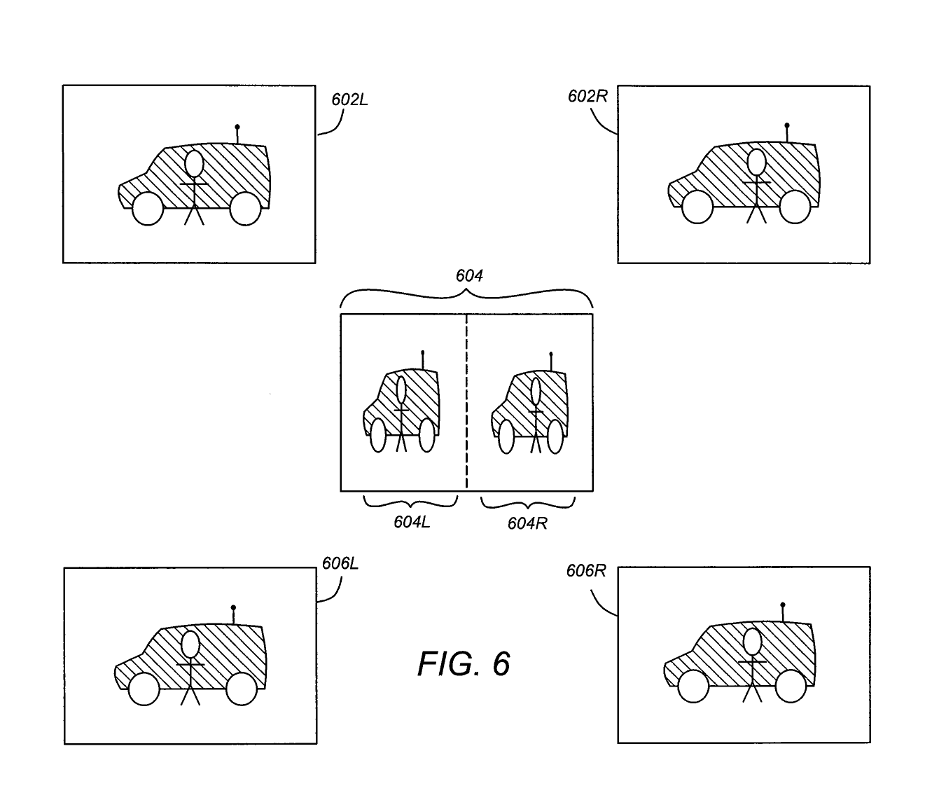

FIGS. 6-9 are diagrams depicting frame-compatible 3D formats. 3D frame compatibility means that the information required to render a 3D image is embedded in a single frame of video in a conventional format (e.g. 1920 pixels by 1080 lines scanned progressively at 24 frames per second, or 1920 pixels by 1080 lines scanned in interlaced format at 30 frames per second). In these protocols, a video frame comprises two subframes of information that are used to depict a 3D image.

An image intended to be presented to the left eye of the viewer 602L is an image intended to be presented to the right eye of the viewer 602R are generated. This can be accomplished using a 3D camera, which may have two lenses to record a scene from different perspectives and appropriate circuitry so as to separately process and record images from the perspectives. Alternatively, the left 602L and right 602R images may be generated separately (for example, using a computer). The illusion of a 3D image is accomplished by presenting one image of the scene to one (e.g. the left) eye, and another image (e.g. one that is from a perspective offset by a few inches to the right) of the other (e.g. right) eye.

FIG. 6 is a diagram illustrating the side-by-side frame compatible format. In this format, the images 602L and 602R are horizontally compressed to one half of their width, and combined into a single composite video frame 604, thus defusing a left subframe 604L and a right subframe 604R in the video frame 604. For example, in a case where the total video resolution is 1920 pixels by 1080 lines, the information for the left eye will be in the rectangle from pixel 1 through pixel 960 and line 1 through line 1080, the information for the right eye will be in the rectangle from pixel 961 to pixel 1920 and line 1 through 1080.

The video frame 604 having the left subframe 604L and the right subframe 604R is transmitted by the headend to the receiver 500 where it is processed as a 2D video frame would be, and thereafter provided to the display 122. If the display 121 is 3D compatible, it processes the provided signal such that the left subframe 604L and the right subframe 604R are expanded to their uncompressed size to produce expanded left subframe 606L and expanded right subframe 606R and provided to the left and right eyes of the subscriber 122. This may be accomplished by presenting the expanded left subframe 606L and the expanded right subframe 606R alternately, while simultaneously providing a signal to a pair of glasses worn by the subscriber 121 to command the left and right eyepieces of the glasses to shutter so that the right eyepiece is opaque when the expanded left subframe 606L is presented by the display 121, and so that the left eyepiece is opaque when the expanded right subframe 606R is presented by the display 121. Other presentation schemes are also possible, including those in which the expanded left and right subframes 606L and 606R are polarized before being displayed, and the subscriber wears glasses having polarized eyepieces so that only the information in the expanded left subframe 606L is seen by the left eye and only the information in the expanded right subframe 606R is seen by the right eye.

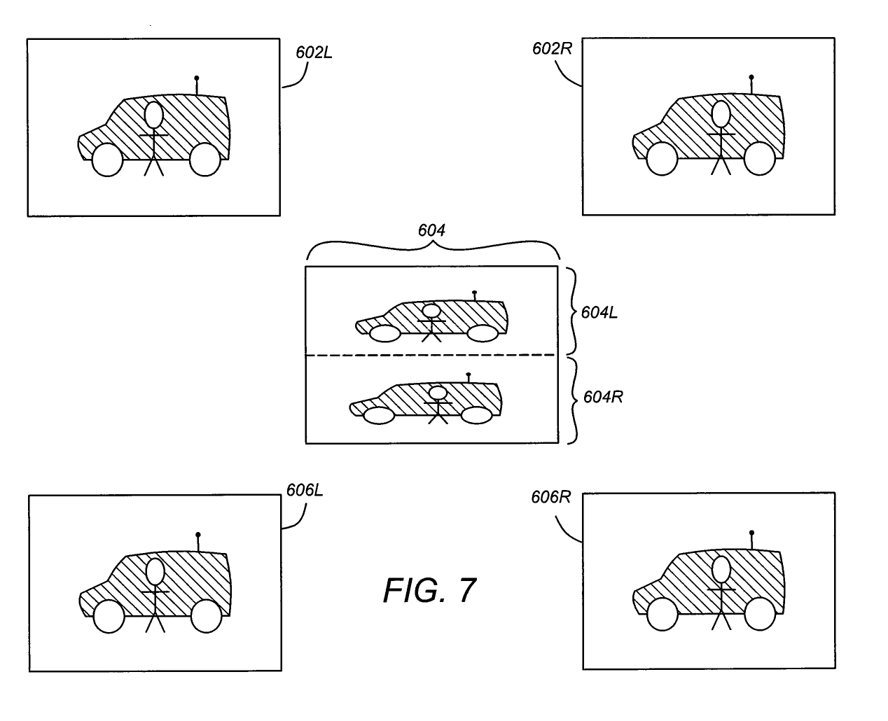

FIG. 7 is a diagram depicting the over and under or top/bottom frame compatible format. This format is similar to the side-by-side format, except that the left image 602L and right image 602R are vertically compressed and oriented one on top of the other. The resulting video frame 604 comprises a left subframe 604L and right subframe 604R. A blank column of pixels may be disposed between the left subframe 604L and the right subframe 604R, if desired. If the total video frame resolution is 1920 pixels by 1080 lines, the left subframe 604L may be a rectangle from pixel 1 through pixel 1920 and line 1 through line 540, and the right subframe 605R may be in the rectangle from pixel 1 to pixel 1920 and line 541 through 1080. When processed by the display device 121, the left subframe 604L and the right subframe 604R are vertically expanded and presented alternately as described above with respect to the side by side format.

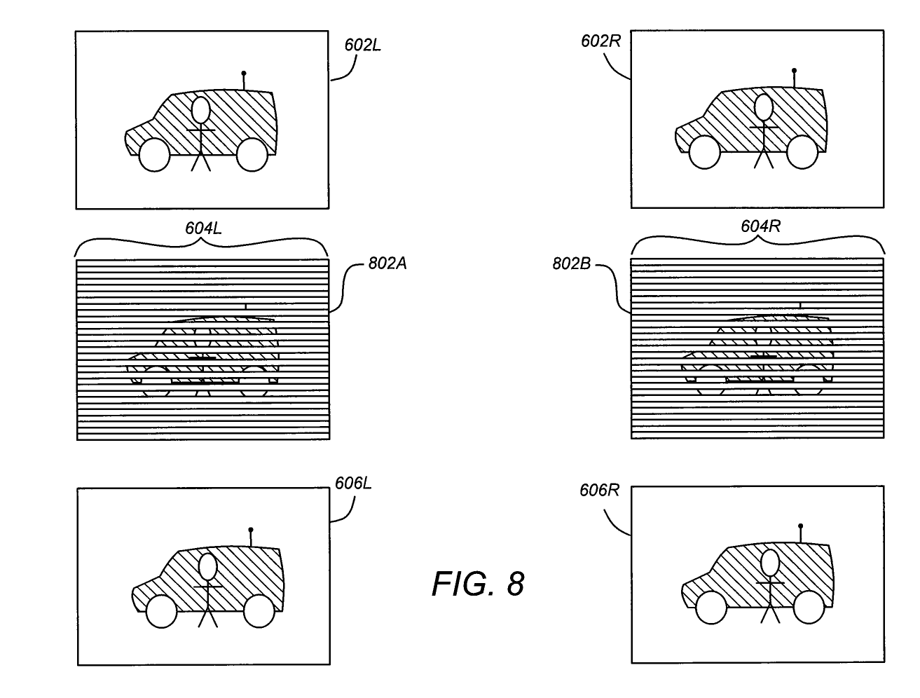

FIG. 8 is a diagram depicting a line alternate frame compatible 3D format. In this format, the left image 602L and right image 602R presented in alternating lines of the video frame 604. For example, odd numbered lines of video may carry the left image 602L and even numbered lines of video may carry the right image 602R, thus defining the left subframe 604L and the rights subframe 604R, respectively. The width of the “lines” may be one pixel, with each alternating line comprising one row of pixels, or may comprise a plurality of pixels. In cases where the lines comprise a plurality of pixels, the left image 602L and right image 602R may be vertically compressed so as to fit within the line. The 3D image can be presented as described with respect to the side-by-side format. In other words, the left subframe 604L may be provided alternately with the right subframe 604R, and the eyepieces of the glasses worn by viewers appropriately shuttered one at a time. Or, the left subframe 604L and right subframe 604R can be provided at the same time, but using different polarlizations matched to the eyepieces of the glasses worn by the subscriber 122.

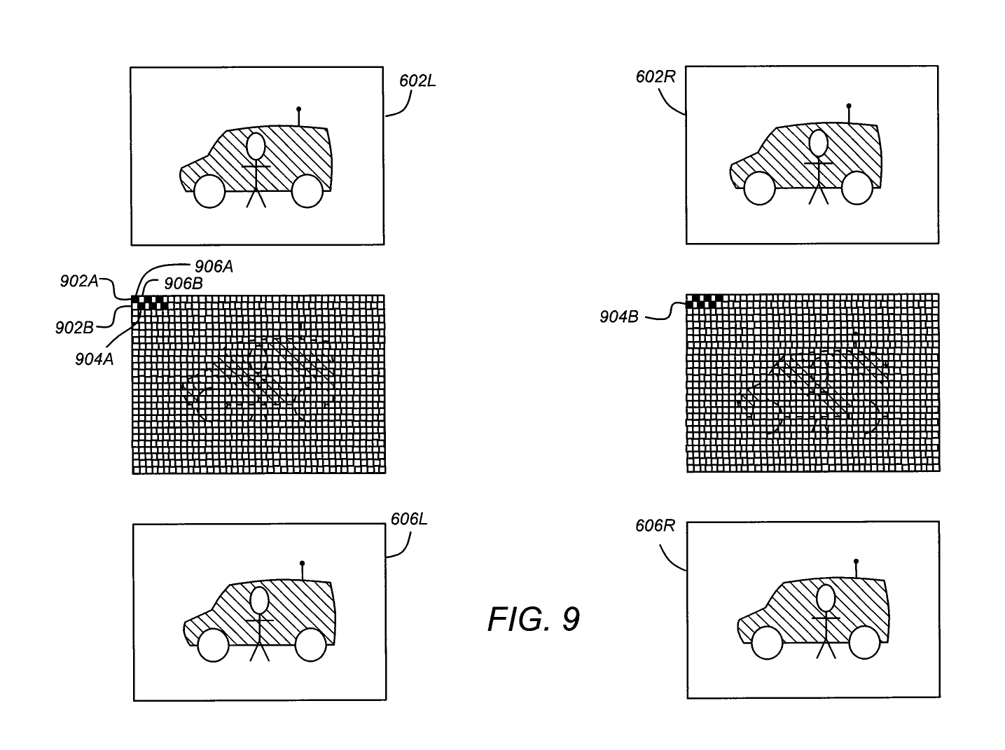

FIG. 9 is a diagram depicting a checkerboard frame compatible 3D format. In this 3D compatible frame format, alternating pixels of each row 902A, 902B of pixels line carry information for the left eye and right eye respectively, and the polarity of the alternation changes from one row to the next (i.e. alternating “left-right-left right” on one row and “right-left-right-left” on the next row). This creates a first checkerboard of pixels 904A (only six of the pixels in the first checkerboard are illustrated in FIG. 9) and a second checkerboard 904B of pixels (again, with only six of the pixels in the second checkerboard of pixels 904B illustrated in FIG. 9) comprising those pixels in the frame 604 that are not in the first checkerboard. For example, the odd numbered rows (such as row 902A) of pixels of the composite video frame 604 may carry the information from the left image 602L in the odd numbered pixel columns and the information from the right image 602R in the odd numbered pixel columns, while even numbered pixel rows carry the information from the left image in the even numbered pixel columns and the information for the right image 602L in the odd numbered pixel columns. Hence, in a video frame that comprises a plurality of pixels arranged in n rows and m columns and each pixel is associated with a row and column, the left subframe 604L includes every other pixel beginning with the first pixel in the even rows and ever other pixel beginning with the second pixel in the odd rows, while the right subframe 604R comprises every other pixel beginning with a second pixel in the even rows and every other pixel beginning with the first pixel in the odd rows. Once again, the left subframe 604L (the first checkerboard 904A) may be provided alternately with the right subframe 604R (the second checkerboard 904B), and the eyepieces of the glasses worn by viewers appropriately shuttered one at a time. Or, the left subframe 604L and right subframe 604R can be provided at the same time, but using different polarlizations matched to the eyepieces of the glasses worn by the subscriber 122.

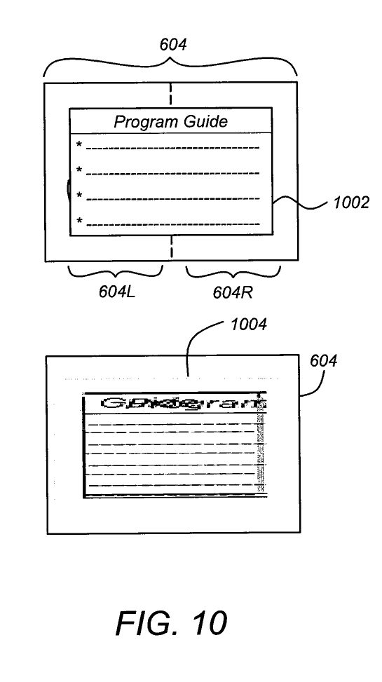

FIG. 10 is a diagram illustrating the result if an OSD were added to a background video frame 604 using a frame compatible side-by side format. The OSD 1002 is overlaid on the video frame 604 (or plurality of background video frames 604 if the background comprises a moving image) and thus, different portions of the OSD 1002 are on the left subframe 604L and the right subframe 604R. When the display 121 combines the two images to present a 3D image to the subscriber 122, the subscriber will see the left portion of the OSD 1002 overlaid on the right portion of the OSD 1002, rendering a jumbled appearance 1004.

One possible solution to this problem is that the OSD may be generated, compressed (or generated with fewer pixels in the first place), and placed in both the left subframe 604L and the right subframe 604R of the background video frame 604. The problem with this solution is that the OSD will be presented with a 2D image, while the background will be presented in a 3D image. Counter-intuitively, the resulting image can cause uncomfortable eyestrain if the foreground and background planes (i.e. the media program and the OSD image) conflict with one another (e.g. there is media program content that appears to be in front of or poking through the OSD image). Even if a 3D image of the OSD could be generated (e.g. using a left OSD image overlaid on the left subframe 604L and a right OSD image overlaid on the right subframe 604R), and the left OSD image overlaid on the left subframe 604L and the right OSD image overlaid on the right subframe 604R, the resulting combined image, when rendered in 3D by the display 122, is surprisingly uncomfortable to read. That is because the apparent location of the OSD image is difficult for the viewer to reconcile with the apparent location of the background image. The present invention resolves this problem by presenting a 2D version of the OSD and a 2D version of the background together.

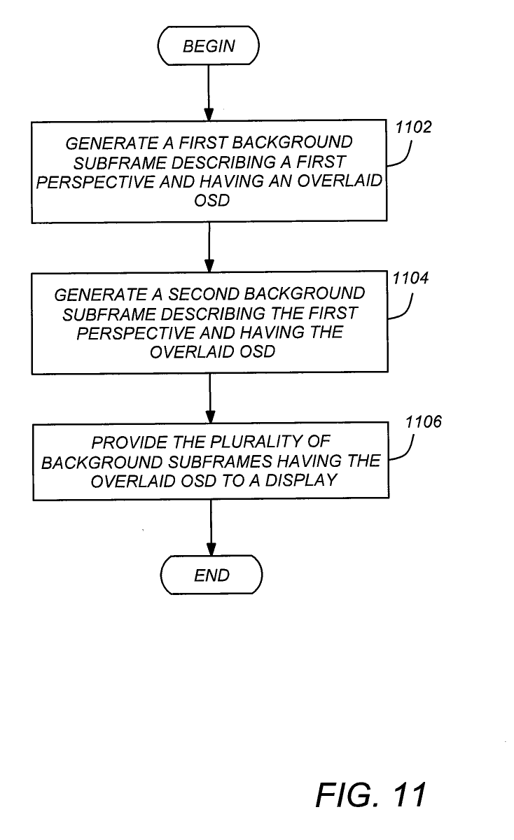

FIG. 11 is a diagram illustrating exemplary method steps that can be used to render the OSD 1002 on one or more decoded video frames before those frames are provided to a display 121 for presentation to the subscriber 122.

In block 1102, a first background subframe is generated describing at least a first perspective and having an overlaid OSD 1002. In block 1104, a second background subframe describing the first perspective and also having the overlaid OSD 1002 is generated. In block 1106, the first and second background subframes, with the overlaid OSDs 1002 are provided to a display 121. The first background subframe may be subframe 604L and the second background subframe may be sub frame 604R.

The technique shown in FIG. 11 can be implemented by generating overlaying an OSD on one of the background subframes, then copying the resulting overlaid background subframe to the other background subframe, or by copying the unoverlaid background subframe to the other unoverlaid background subframe, then overlaying the OSD 1002 on both subframes.

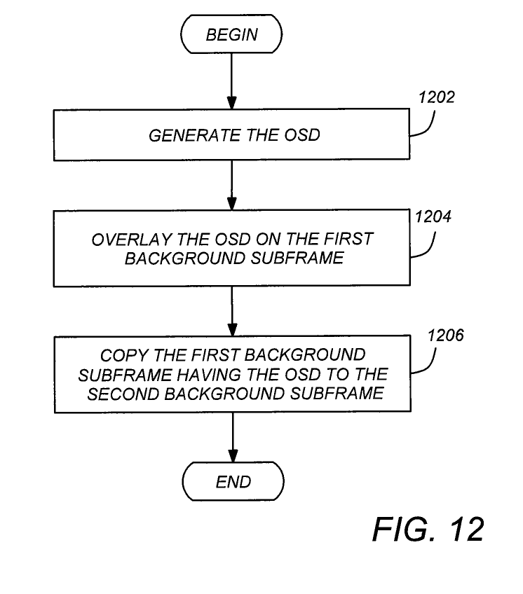

FIG. 12 is a diagram illustrating exemplary method steps in which the first background subframe and overlaid OSD is generated, then copied to second background subframe.

In block 1202, the OSD is generated. In one embodiment, this is accomplished in the receiver 500 by processor 510 in response to user input provided using remote control 524 or keyboard interface. For example, the subscriber 122 may request the display of a program guide by selecting the appropriate button on the remote control 524. Using instructions stored in the RAM 550, the flash memory 552 or internal to the processor 510, the processor 510 retrieves program guide information and generates an OSD 1002 which is represented by a plurality of pixels which together present the program guide information.

In block 1204, the OSD 1002 is overlaid on the first background subframes, for example, the left background subframe 604L. This can be accomplished, for example by performing a pixel-by-pixel substitution of the pixels of the generated OSD 1002 for the corresponding pixels of the background subframe 604L. Alternatively, only some of the OSD pixels may be substituted for the corresponding pixels of the background subframe 604L. This allows the OSD 1002 to appear somewhat translucent and allow some of the background subframe 604L image to be presented.

The generated OSD 1002 must match the frame compatible 3D format of the background frame 604. For example, with respect to the side-by-side or top/bottom frame compatible format, the OSD 1002 must be generated to one half the size that would be used with a 2D video frame, or generated to the standard size, and reduced in the appropriate dimension. Therefore, in this format, the OSD 1002 must either be generated so as to not exceed 960 pixels horizontally or generated at a larger size and compressed to a size that does not exceed 960 horizontal pixels (for example, by eliminating every other pixel in the horizontal direction). Likewise, the top/bottom format requires that the OSD 1002 be limited to 540 pixels in the vertical direction or compressed to this size.

If the line alternating frame-compatible 3D format is used, the OSD 1002 is generated or a standard OSD 1002 is generated and processed so that the result occupies no more than every other line (or row of pixels) such as the lines or pixels shown in the left subframe 604L of FIG. 8.

Similarly, if the checkerboard frame-compatible 3D format is used, the generated or processed OSD 1002 occupies no more than a checkerboard of pixels such as first checkerboard 904A, as shown in FIG. 9.

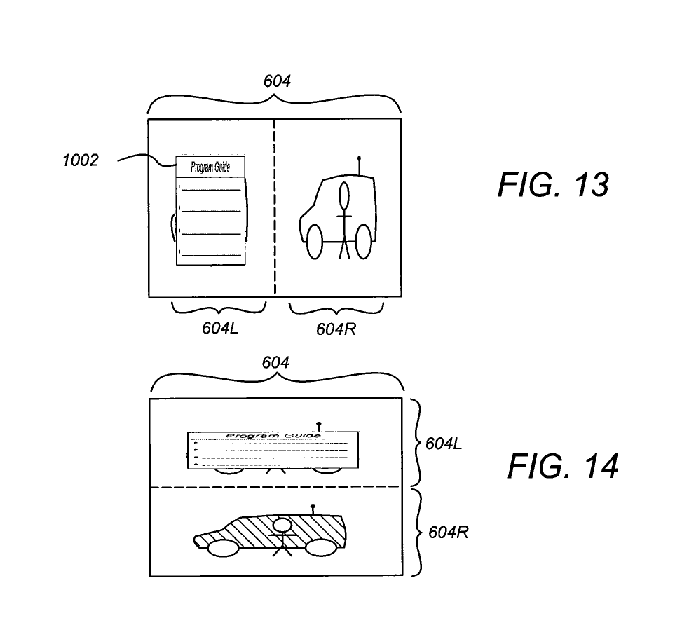

FIGS. 13 and 14 are diagrams illustrating how the background subframe 604L may appear after the OSD 1002 is overlaid in the side-by-side and top/bottom frame-compatible 3D formats, respectively. In the alternating line and checkerboard frame-compatible 3D formats, the OSD 1002 would appear to be within the within the frame 604, but in only alternating lines (or lines and pixels).

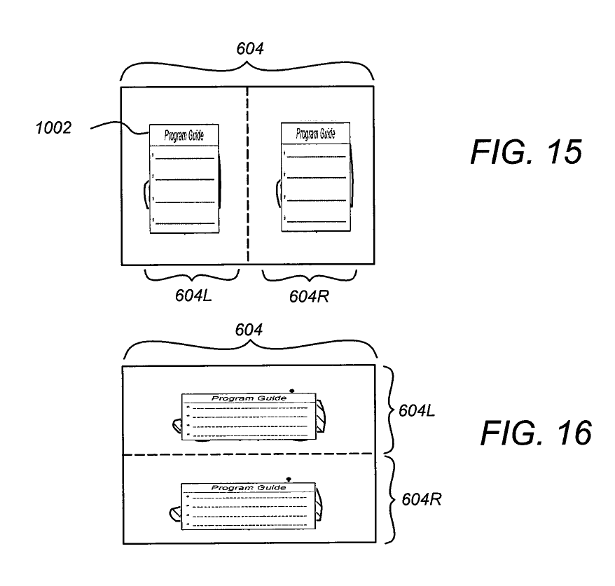

Returning to FIG. 12, the first background subframe 604L having the overlaid OSD 1002 is copied to second background subframe 604R, as shown in block 1206. As a result, both the left background subframe 604L and the right background subframe 604R have exactly the same information, as shown in FIGS. 15 and 16. The background subframes 604L and 604R (each now having the same background subframe image (e.g. 602L) and the same overlaid OSD 1002 are provided to the display 121 for presentation to the subscriber 122. Since the information in each subframe 604L and 604R is identical, the viewer will perceive a 2D image with a 2D version of the OSD 1002. Since only 2D images are shown, the result does not cause eyestrain, and is pleasant to use.

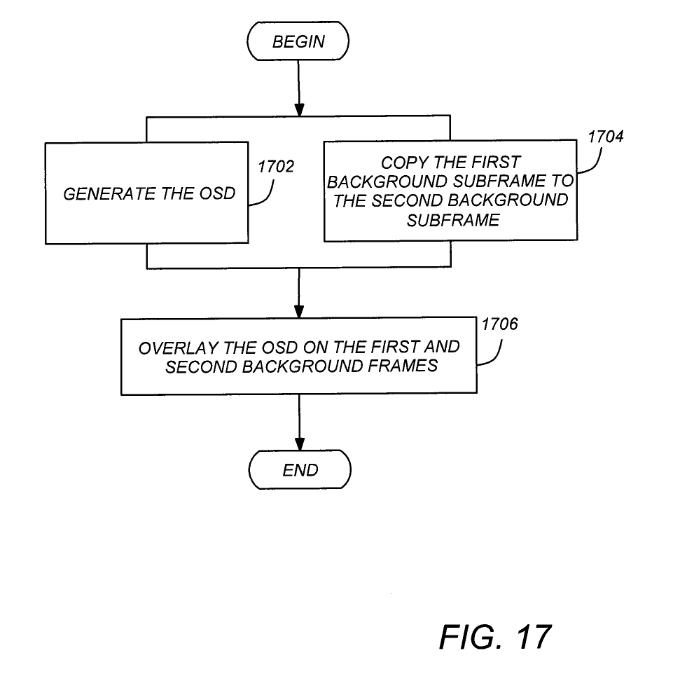

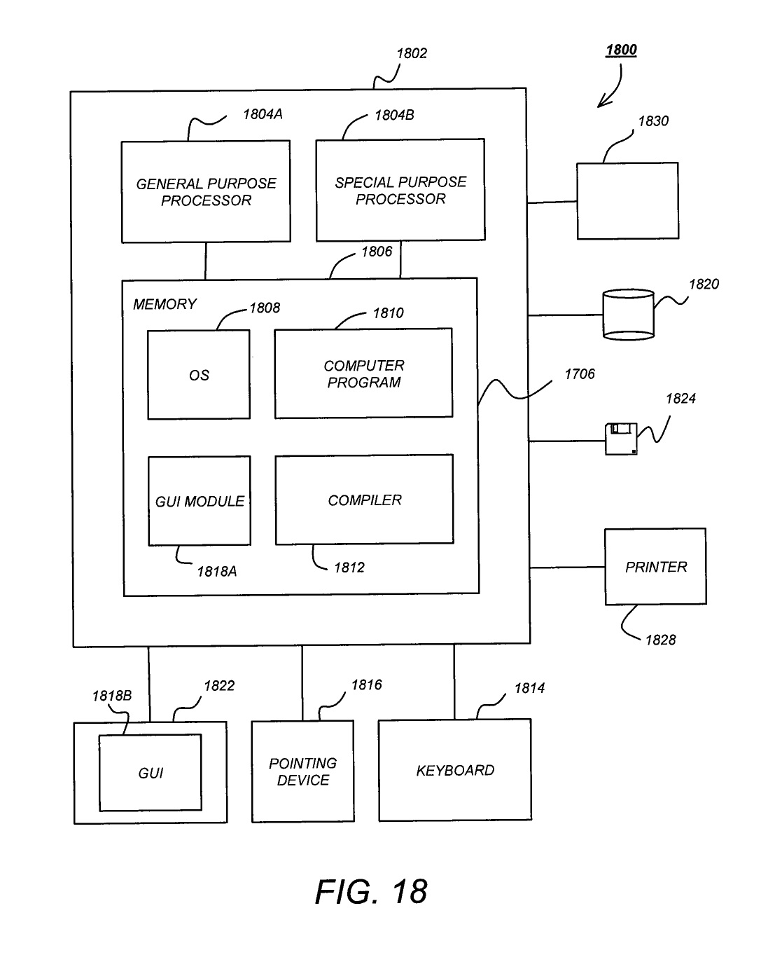

FIG. 17 is a diagram illustrating another embodiment of exemplary method steps that can be used to render the OSD 1002 on one or more decoded video frames before those frames are provided to a display 121 for presentation to the subscriber 122. In this embodiment, one of the plurality of background subframes is copied to the other of the plurality of subframes, and the same OSD is overlaid on both subframes.

In block 1702, the OSD 1002 is generated. In block 1704, the information in the first background subframe is copied to the second background subframe. For example, the information in background subframe 604L may be copied to background subframe 604R. The generated OSD 1002 is then overlaid on the first and second background subframes, as shown in block 1706.

FIG. 18 is a diagram illustrating an exemplary computer system 1800 that could be used to implement elements of the present invention. The computer 1802 comprises a general purpose hardware processor 1804A and/or a special purpose hardware processor 1804B (hereinafter alternatively collectively referred to as processor 1804) and a memory 1806, such as random access memory. The computer 1802 may be coupled to other devices, including I/O devices such as a keyboard 1814, a mouse device 1816 and a printer 1828.

In one embodiment, the computer 1802 operates by the general-purpose processor 1804A performing instructions defined by the computer program 1810 under control of an operating system 1808. The computer program 1810 and/or the operating system 1808 may be stored in the memory 1806 and may interface with the user and/or other devices to accept input and commands and, based on such input and commands and the instructions defined by the computer program 1810 and operating system 1808 to provide output and results.

Output/results may be presented on the display 1822 or provided to another device for presentation or further processing or action. In one embodiment, the display 1822 comprises a liquid crystal display (LCD) having a plurality of separately addressable pixels formed by liquid crystals. Each pixel of the display 1822 changes to an opaque or translucent state to form a part of the image on the display in response to the data or information generated by the processor 1804 from the application of the instructions of the computer program 1810 and/or operating system 1808 to the input and commands. Other display 1822 types also include picture elements that change state in order to create the image presented on the display 1822. The image may be provided through a graphical user interface (GUI) module 1818A. Although the GUI module 1818A is depicted as a separate module, the instructions performing the GUI functions can be resident or distributed in the operating system 1808, the computer program 1810, or implemented with special purpose memory and processors.

Some or all of the operations performed by the computer 1802 according to the computer program 1810 instructions may be implemented in a special purpose processor 1804B. In this embodiment, some or all of the computer program 1810 instructions may be implemented via firmware instructions stored in a read only memory, a programmable read only memory or flash memory within the special purpose processor 1804B or in memory 1806. The special purpose processor 1804B may also be hardwired through circuit design to perform some or all of the operations to implement the present invention. Further, the special purpose processor 1804B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 1802 may also implement a compiler 1812 which allows an application program 1810 written in a programming language such as COBOL, C++, FORTRAN, or other language to be translated into processor 1804 readable code. After completion, the application or computer program 1810 accesses and manipulates data accepted from I/O devices and stored in the memory 1806 of the computer 1802 using the relationships and logic that was generated using the compiler 1812.

The computer 1802 also optionally comprises an external communication device such as a modem, satellite link, Ethernet card, or other device for accepting input from and providing output to other computers.

In one embodiment, instructions implementing the operating system 1808, the computer program 1810, and/or the compiler 1812 are tangibly embodied in a computer-readable medium, e.g., data storage device 1820, which could include one or more fixed or removable data storage devices, such as a zip drive, floppy disc drive 1824, hard drive, CD-ROM drive, tape drive, or a flash drive. Further, the operating system 1808 and the computer program 1810 are comprised of computer program instructions which, when accessed, read and executed by the computer 1802, causes the computer 1802 to perform the steps necessary to implement and/or use the present invention or to load the program of instructions into a memory, thus creating a special purpose data structure causing the computer to operate as a specially programmed computer executing the method steps described herein. Computer program 1810 and/or operating instructions may also be tangibly embodied in memory 1806 and/or data communications devices 1830, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 1802.

Although the term “computer” is referred to herein, it is understood that the computer may include portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of rendering an on-screen display (OSD) on a background frame having a plurality of background subframes together defining a three dimensional image, comprising the steps of:
generating a first background subframe describing a first perspective and having an overlaid OSD;
generating a second background subframe describing the first perspective and having the overlaid OSD; and
providing the first background subframe describing the first perspective and having the overlaid OSD and the second background subframe having the overlaid OSD to a display.

2. The method of claim 1, wherein:
the step of generating a first background subframe describing a first perspective and having an overlaid OSD comprises the steps of:
generating the OSD; and
overlaying the OSD on the first background subframe;
the step of generating the second background subframe describing the second perspective having the overlaid OSD comprises the step of:
copying the first background subframe having the OSD to the second background sub frame.

3. The method of claim 1, wherein:
the step of generating the second background subframe describing the second perspective having the overlaid OSD comprises the steps of:
copying the first background subframe to the second background subframe;
generating the OSD; and
overlaying the OSD on the second background subframe;
the step of generating a first background subframe describing a first perspective and having an overlaid OSD comprises the step of:
overlaying the OSD on the first background subframe.

4. The method of claim 1, wherein the first background subframe comprises a left portion of the background frame and the second background subframe comprises a right portion of the background frame.

5. The method of claim 4, wherein the first perspective is a left eye perspective and the second perspective is a right eye perspective.

6. The method of claim 1, wherein the first background subframe comprises an upper portion of the background frame and the second background subframe comprises a lower portion of the background frame.

7. The method of claim 6, wherein the first perspective is a left eye perspective and the second perspective is a right eye perspective.

8. The method of claim 1, wherein the background frame comprises a plurality of rows and the first background subframe comprises odd rows of the background frame and a second background subframe comprises even rows of the background subframe.

9. The method of claim 1, wherein the background subframe comprises a plurality of pixels and the first background subframe comprises a checkerboard of the pixels and a second background subframe comprising the remaining of the plurality of pixels.

10. The method of claim 1, wherein the background frame comprises a plurality of pixels arranged in a plurality of n rows and m columns with each pixel associated with a row and column, and wherein:
the first background subframe comprises every other pixel beginning with a first pixel in the even rows and every other pixel beginning with the second pixel in the odd rows; and
the second subframe comprises every other pixel beginning with a second pixel in the even rows and every other pixel beginning with the first pixel in the odd rows.

11. An apparatus rendering an on-screen display (OSD) on a background frame having a plurality of background subframes together defining a three dimensional image, comprising:
means for generating a first background subframe describing a first perspective and having an overlaid OSD;
means for generating a second background subframe describing the first perspective and having the overlaid OSD; and
means for providing the first background subframe describing the first perspective and having the overlaid OSD and the second background subframe having the overlaid OSD to a display.

12. The apparatus of claim 11, wherein:
the means for generating a first background subframe describing a first perspective and having an overlaid OSD comprises:
means for generating the OSD; and
means for overlaying the OSD on the first background subframe;
the means for generating the second background subframe describing the second perspective having the overlaid OSD comprises:
means for copying the first background subframe having the OSD to the second background subframe.

13. The apparatus of claim 11, wherein:
the means for generating the second background subframe describing the second perspective having the overlaid OSD comprises:
means for copying the first background subframe to the second background subframe; and
means for generating the OSD; and
means for overlaying the OSD on the second background subframe;
the means for generating a first background subframe describing a first perspective and having an overlaid OSD comprises:
means for overlaying the OSD on the first background subframe.

14. The apparatus of claim 11, wherein the first background subframe comprises a left portion of the background frame and the second background subframe comprises a right portion of the background frame.

15. The apparatus of claim 14, wherein the first perspective is a left eye perspective and the second perspective is a right eye perspective.

16. The apparatus of claim 11, wherein the first background subframe comprises an upper portion of the background frame and the second background subframe comprises a lower portion of the background frame.

17. The apparatus of claim 16, wherein the first perspective is a left eye perspective and the second perspective is a right eye perspective.

18. The apparatus of claim 11, wherein the background frame comprises a plurality of rows and the first background subframe comprises odd rows of the background frame and a second background subframe comprises even rows of the background subframe.

19. The apparatus of claim 11, wherein the background subframe comprises a plurality of pixels and the first background subframe comprises a checkerboard of the pixels and a second background subframe comprising the remaining of the plurality of pixels.

20. The apparatus of claim 11, wherein the background frame comprises a plurality of pixels arranged in a plurality of n rows and m columns with each pixel associated with a row and column, and wherein:
the first background subframe comprises every other pixel beginning with a first pixel in the even rows and every other pixel beginning with the second pixel in the odd rows; and
the second subframe comprises every other pixel beginning with a second pixel in the even rows and every other pixel beginning with the first pixel in the odd rows.

21. An apparatus for rendering an on-screen display (OSD) on a background frame having a plurality of background subframes frames together defining a three dimensional image, comprising the steps of:
a processor, communicatively coupled to a memory, the memory storing instructions comprising:
instructions for generating a first background subframe describing a first perspective and having an overlaid OSD;
instructions for generating a second background subframe describing the first perspective and having the overlaid OSD; and
instructions for providing the first background subframe describing the first perspective and having the overlaid OSD and the second background subframe having the overlaid OSD to a display.

22. The apparatus of claim 21, wherein:
the instructions for generating a first background subframe describing a first perspective and having an overlaid OSD comprise:
instructions for generating the OSD;
instructions for overlaying the OSD on the first background subframe;
the instructions for generating the second background subframe describing the second perspective having the overlaid OSD comprise:
instructions for copying the first background subframe having the OSD to the second background subframe.

23. The apparatus of claim 21, wherein:
the instructions for generating the second background subframe describing the second perspective having the overlaid OSD comprises instructions for:
copying the first background subframe to the second background subframe; and
generating the OSD; and
overlaying the OSD on the second background subframe;
the instructions for generating a first background subframe describing a first perspective and having an overlaid OSD comprises instructions for:
overlaying the OSD on the first background subframe.
